(19) United States
(12) Patent Application Publication
(10) Pub. No.: US 2011/0046812 A1
(43) Pub. Date: Feb. 24, 2011

(54) DEVICE AND METHOD FOR COOLING FAN CONTROL USING MEASURED AMPERAGE LOAD

(76) Inventors: Peter Hansen, Cypress, TX (US); Wade D. Vinson, Magnoiia, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/937,930

(22) PCT Filed: Apr. 19, 2008
(86) PCT No.: PCT/US08/60949

§ 371 Date: Oct. 14, 2010

(51) Int. Cl. G05D 23/19

(52) U.S. Cl. 700/300

(57) ABSTRACT

A system and method for controlling cooling fans in a computing system using measured temperature and amperage load is disclosed. In one embodiment, a cooling fan control device (CFCD) includes a temperature sensing module for measuring an inside temperature of the computing system using a plurality of temperature sensors disposed within the computing system and for computing a temperature value during operation, a power measurement module for measuring amperage drawn by each of the plurality of cooling fans during operation, and a driving module coupled to the temperature sensing module and the power measurement module to adjust rotational speed of each of the plurality of cooling fans during operation to obtain a desired airflow across the inside of the computing system based on the computed temperature value, a desired temperature value, and a lookup table including temperature and amperage drawn versus airflow values associated with each cooling fan.

### BACKGROUND

Cooling fans are disposed in various types of electronic devices and computing systems to facilitate heat dissipation in these devices and systems. However, conventional fan control devices adjust rotational speed of the cooling fans based on variation of temperature, i.e., based on thermal variations and needs. The conventional cooling fans are set at fixed rotational speeds (RPM values) based on thermal needs. These fixed rotational speeds, i.e., set points, are obtained by building various prototypes including cooling fans at fixed locations and running at fixed speeds in thermal labs. In other words, rotational speed of the cooling fan is typically not adjusted based on heat dissipation or airflow characteristics in the electronic devices and the computing systems on real time basis but on predetermined tables of the calibrated thermal sensors. Tests in the thermal labs can take considerable amount of time to obtain desired fixed speeds.

However, these techniques do not always yield efficient and/or consistent airflow across components in relation to the power consumed by the cooling fans in the electronic devices and the computing systems. In addition, due to multiple configurations at various loads and suboptimal placement of thermal sensors for all loads, these conventional approaches require including a significant amount of tolerance in the amount of airflow desired, i.e., they can require over provisioning the amount of airflow required, across the components in the electronic devices and the computing systems. This can result in using significantly more power than needed to maintain a desired airflow across the components.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram illustrating a plurality of cooling fans and a plurality of server blades arranged in a typical computing system, such as a server, according to one embodiment.

FIG. 2 is a block diagram illustrating the cooling fan device (CFCD) of FIG. 1, according to one embodiment.

FIG. 3 is an example graph showing relationship of impedance, differential static pressure in inches of water gage and power drawn by a cooling fan in watts versus airflow in cubic feet per minute (CFM) of the cooling fan used in a typical computing system.

FIG. 4 is an example graph showing power consumption of each of a plurality of cooling fans used during operation of the computing system.

FIG. 5 is a flowchart illustrating a cooling fan control method used in the computing system, according to one embodiment.

Other features of the present embodiments will be apparent from the accompanying drawings and from the detailed description that follows.

### DETAILED DESCRIPTION

A system and method for controlling cooling fans used in a computing system using measured amperage load of cooling fans is disclosed. In the following description, for purposes of explanation, numerous specific details are set forth in order to provide a thorough understanding of the various embodiments. It will be evident, however, to one skilled in the art that the various embodiments may be practiced without these specific details.

The terms “amperage”, “power” and “fan current” are used interchangeably throughout the document.

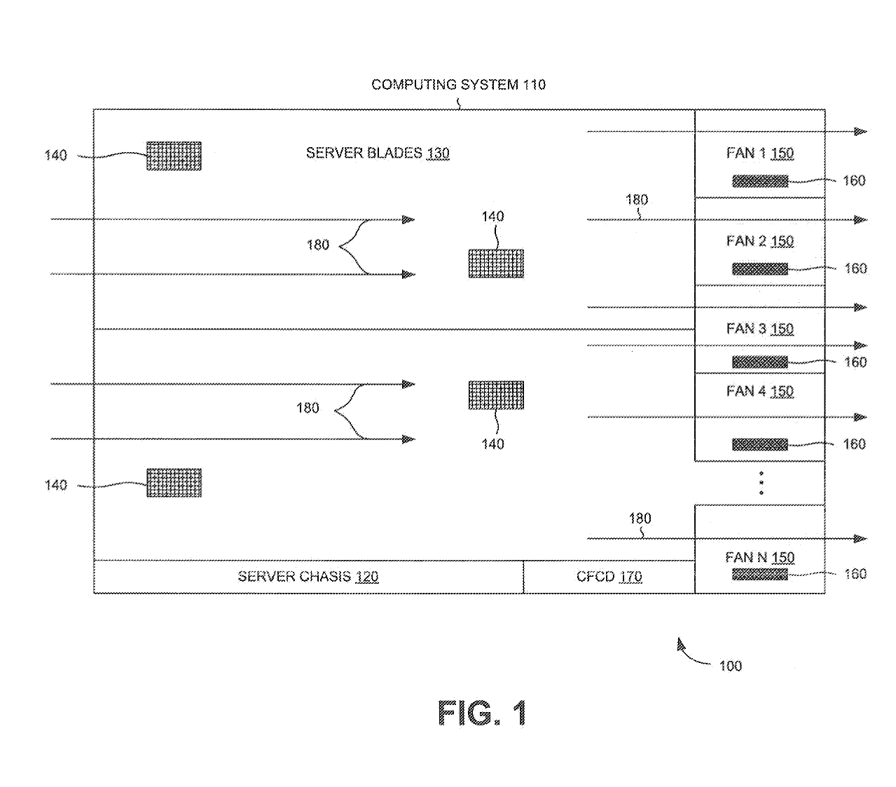

FIG. 1 is a block diagram 100 illustrating a plurality of cooling fans 150 1-N and a plurality of server blades 130 arranged in a typical computing system 110, such as a server, according to one embodiment. Particularly, FIG. 1 illustrates the computing system 110 including a server chassis 120, the plurality of server blades 130, a plurality of temperature sensors 140, the plurality of cooling fans 150 1-N, a plurality of amperage sensors 160 associated with each of the plurality of cooling fans 150 1-N and a cooling fan control device (CFCD) 170. Also, shown in FIG. 1 is airflow path 180 across the plurality of server blades 130 and through cooling fan blades during normal operation of the computing system 110.

The server chassis 120 may refer to a rigid framework on which the server blades 130, the cooling fans 150 1-N and the temperature sensors 140 are disposed in the computing system 110. The server blade 130 may refer to a thin, modular electronic circuit board including one or more microprocessors and memory. In these embodiments, the temperature sensors 140 are disposed at various locations on the server chassis 120 and the server blades 130 to measure inside temperatures of the computing system 110.

In some embodiments, the cooling fans 150 1-N having the cooling fan blades are disposed on the server chassis 120 such that the cooling fans 150 1-N can create airflow across the server blades 130. The amperage sensors 160 measure the amperage drawn by the cooling fans 150 1-N disposed on the server chassis 120 during operation. In some embodiments, each cooling fan 150 has an associated amperage sensor 160 to measure the amperage drawn.

The CFCD 170 disposed on the server chassis 120 controls the cooling fans 150 1-N located in the computing system 110. In one embodiment, the CFCD 170 is communicatively coupled to the temperature sensors 140 and the amperage sensor 160 associated with each cooling fan 150 for controlling the cooling fans 150 1-N. During operation, the CFCD 170 measures inside temperature across the server blades 130 using the temperature sensors 140 and computes a temperature value.

Further during operation, the CFCD 170 measures amperage (e.g., in amps) drawn by each cooling fan 150 using the associated amperage sensors 160. In some embodiments, the CFCD 170 adjusts rotational speed of each cooling fan 150 based on the computed temperature value and a desired temperature value (e.g., which is based on temperature of components requiring thermal control) to obtain a desired airflow (e.g., in cubic feet per minute (CFM)) across the server blades 130 and via the cooling fan blades using a lookup table including temperature and amperage drawn versus airflow values for each cooling fan 150. In these embodiments, the CFCD 170 includes a read only memory (ROM) device or a random access memory (RAM) device in which the lookup table is stored.

Further, the CFCD 170 adjusts the rotational speed of the cooling fans 150 1-N to obtain the desired airflow across server blades 130 and via the cooling fans 150 1-N to meet the desired temperature based on a computed temperature value and a cooling fan amperage balancing algorithm.

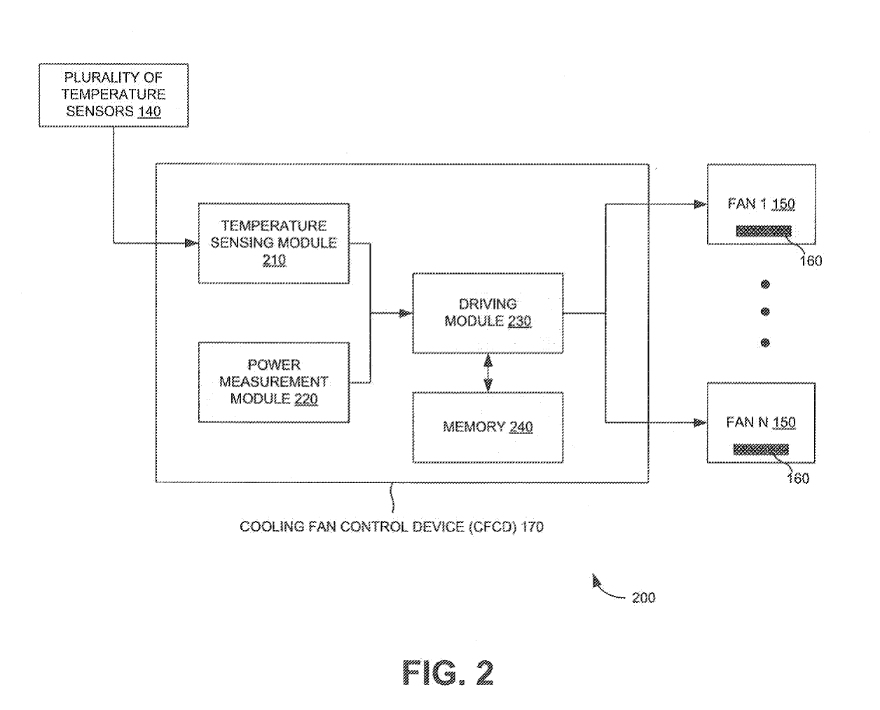

FIG. 2 is a block diagram 200 illustrating the CFCD 170 of FIG. 1, according to one embodiment. Particularly, FIG. 2 illustrates the CFCD 170 including a temperature sensing module 210, a power measurement module 220, a driving module 230 coupled to the plurality of cooling fans 150 1-N including associated amperage sensors 160, and a memory 240. Also shown in FIG. 2, is the temperature sensing module 210 communicatively coupled to the plurality of temperature sensors 140 disposed in the computing system 110.

The CFCD 170 controls the cooling fans 150 1-N disposed on the server chassis 120 for optimum airflow (e.g., in cubic feet per minute (CFM)) inside the computing system 110. In some embodiments, the temperature sensing module 210, the power measurement module 220 and the driving module 230 of the CFCD 170 are configured for controlling the airflow of the cooling fans 150 1-N in the computing system 110. The temperature sensing module 210 measures inside temperature of the computing system 110 using the temperature sensors 140 (e.g., communicatively coupled with the temperature sensing module 210) disposed within the computing system 110 and computes a temperature value during operation.

The power measurement module 220 measures amperage (e.g., in amps) drawn by the cooling fans 150 1-N in the computing system 110 using the amperage sensors 160 during operation. For example, each cooling fan 150 has an associated amperage sensor 160 for measuring power drawn by the cooling fan 150. In one embodiment, an analog to digital converter hosted in each of the cooling fan 150 may facilitate conversion of amperage readings (e.g., in analog form) measured by the amperage sensors 160 into a digital form. The driving module 230 coupled to the temperature sensing module 210 and the power measurement module 220 adjusts rotational speed of each of the plurality of cooling fans 150 1-N during operation to obtain a desired airflow across the inside of the computing system 110 based on the computed temperature value, a desired temperature value, and a lookup table including temperature and amperage drawn versus airflow values associated with each cooling fan 150.

In these embodiments, the driving module 230 is coupled to the temperature sensing module 210 and the power measurement module 220 such that the driving module 230 derives information associated with the temperature of the computing system 110 and the amperage drawn by the cooling fans 150 1-N from the temperature sensing module 210 and the power measurement module 220 respectively. The memory 240 may be random access memory (RAM) or read only memory (ROM) used for storing the lookup table including temperature and amperage drawn versus airflow values associated with each cooling fan 150.

In operation, the driving module 230 adjusts the rotational speed of the cooling fans 150 1-N to obtain the desired airflow across the server blades 130 and via the cooling fans 150 1-N based on the computed temperature value and the lookup table including temperature and amperage drawn versus airflow values in CFM stored in the RAM and/or ROM 240. Further, the driving module 230 adjusts the rotational speed of the cooling fans 150 1-N to obtain a desired airflow across the server blades 130 and via the cooling fans 150 1-N to meet the desired temperature value based on the computed temperature value and a cooling fan amperage balancing algorithm. In one embodiment, the desired temperature value is based on temperature of components requiring thermal control.

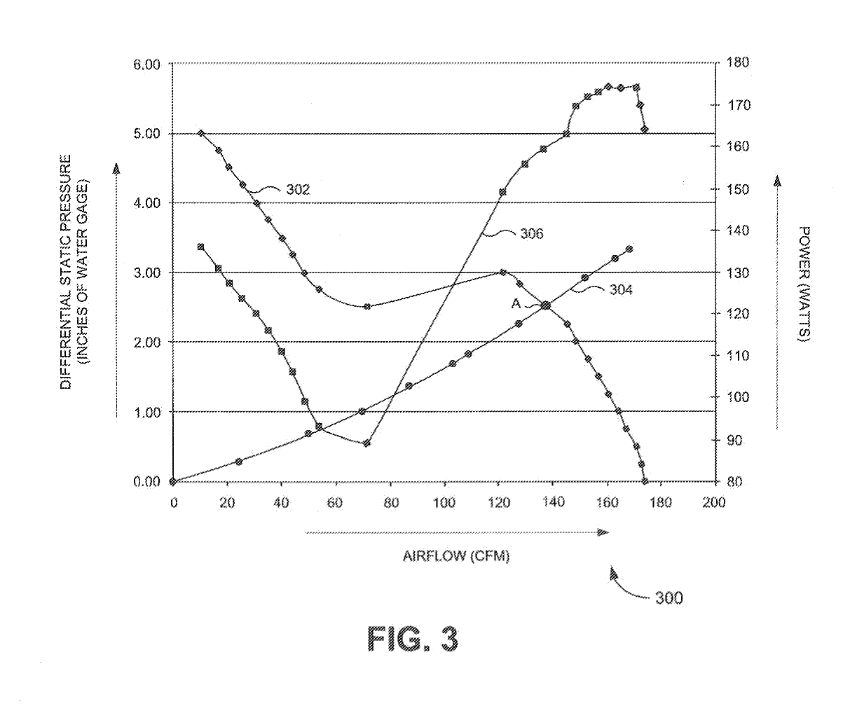

FIG. 3 is an example graph 300 showing relationship of impedance, differential static pressure in inches of water gage and power drawn by the cooling fan 150 in watts versus airflow in cubic feet per minute (CFM) of the cooling fan 150 used in a typical computing system. The horizontal axis of the graph 300 shown in FIG. 3 represents airflow across the inside of the computing system in CFM. Further, a primary vertical axis represents the differential static pressure in inches of water gage and a secondary vertical axis represents power drawn in watts (W) by the cooling fan 150.

As illustrated in FIG. 3, curve 302 is a characteristic fan curve, curve 304 is a computing system impedance curve and curve 306 is a fan power curve. The fan curve 302 indicates that as the airflow decreases, the differential static pressure increases. As shown in the graph 300, the airflow reaches maximum, as the differential static pressure reaches zero. On the other hand, the airflow is minimized or zero, as the differential static pressure reaches maximum. The fan power curve 306 indicates that as the airflow increases, the power drawn by the cooling fan 150 decreases to a certain value and then increases with further increase in the airflow. For example, from the graph 300 it can be observed that, at airflow of 10 CFM, the power drawn by the cooling fan 150 is 136 W which then drops down to 89 W at 71 CFM. Further, it can be observed that there is a steady increase in the power drawn by the cooling fan 150 from 89 W to 149 W at a CFM value of 122.

From FIG. 3 it can been observed that the characteristic fan curve 302 and the impedance curve 304 intersect at a point A, hereinafter referred as an operating point of the cooling fan 150. As shown in the graph 300, at the operating point A, the cooling fan 150 generates airflow of approximately 138 CFM at the differential static pressure of 2.50 inches of water gage, which is actual volumetric airflow rate delivered by the cooling fan 150 at the operating point A, in this example. It is also observed from the graph 300 that the power drawn by the cooling fan 150 for delivering airflow of 138 CFM at the operating point A of the cooling fan 150 is 159 W. However, the point of intersection depends on characteristics of the fan curve 302 and the impedance curve 304.

The characteristic of the impedance curve 304 may vary from one server chassis to another (e.g., due to turbulence in the server chassis 120) and hence the intersection point may vary. In addition, the operating point A for each of the plurality of cooling fans 150 1-N may be different as each of the plurality of cooling fans 150 1-N may have different characteristic curves for different operating voltages (i.e., at different amperage). It may further be inferred that at different operating points, the airflow generated by the cooling fan 150 may vary and also the power consumed by the cooling fan 150 may vary.

Hence, it may be difficult to predict the airflow rate delivered by each of the plurality of the cooling fans 150 1-N in the server chassis 120 without testing the cooling fans 150 1-N. Thus, it is desirable to characterize each of the plurality of cooling fans 150 1-N in order to obtain amperage drawn (i.e., power consumed) by each of the plurality of the cooling fans 150 1-N at various points of the fan curve 302 such that the airflow can be manipulated based on the measured amperage and temperature inside the computing system 110.

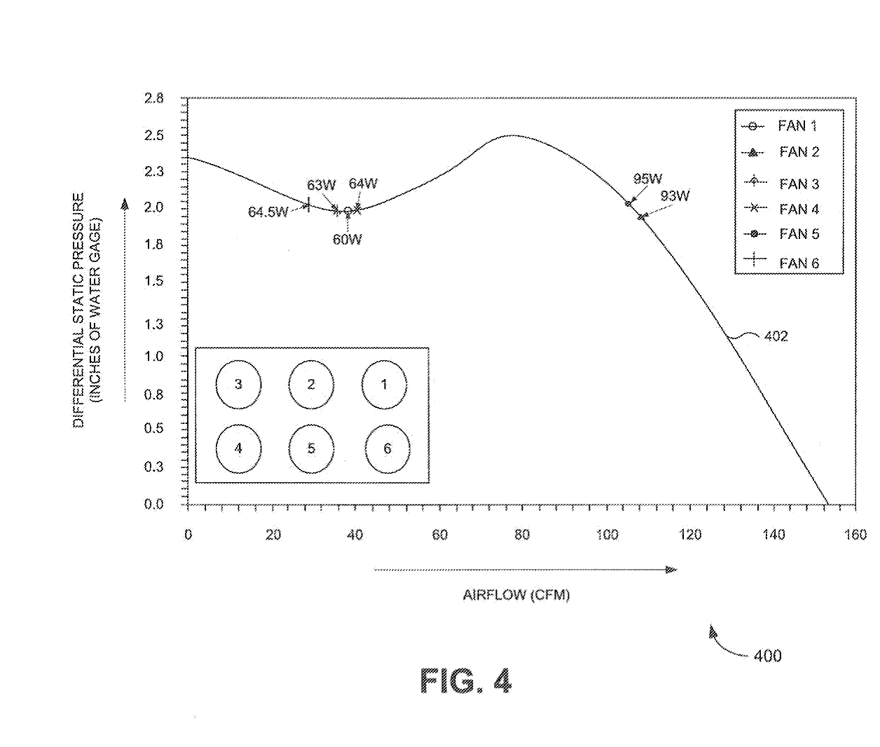

FIG. 4 is an example graph 400 showing power consumption of each of the plurality of cooling fans 150 1-N used during operation of the computing system 110. Particularly, the graph 400 shows a characteristic fan curve 402 and location (e.g., positioning) of the cooling fans 1, 2, 3, 4, 5 and 6 inside the computing system 110. The graph 400 shown in FIG. 4 illustrates power drawn by respective cooling fans at various points along the characteristic fan curve 402. Graphed onto the fan curve 402 shows the power drawn by the cooling fan 1 is 60 W, the cooling fan 2 is 93 W, the cooling fan 3 is 64 W, the cooling fan 4 is 63 W, the cooling fan 5 is 95 W and the cooling fan 6 is 64.5 W. Further, it can be noted from the graph 400 that the airflow generated by the cooling fans 1, 3, 4 and 6 is approximately around 40 CFM whereas the cooling fans 2 and 5 pull around 100 CFM.

With the above information and using a cooling fan amperage balancing algorithm, rotational speed of each of the cooling fans 150 1-N can be adjusted to obtain a required airflow CFM such that a uniform airflow across the inside of the computing system 110 can be ensured by the cooling fans 150 1-N.

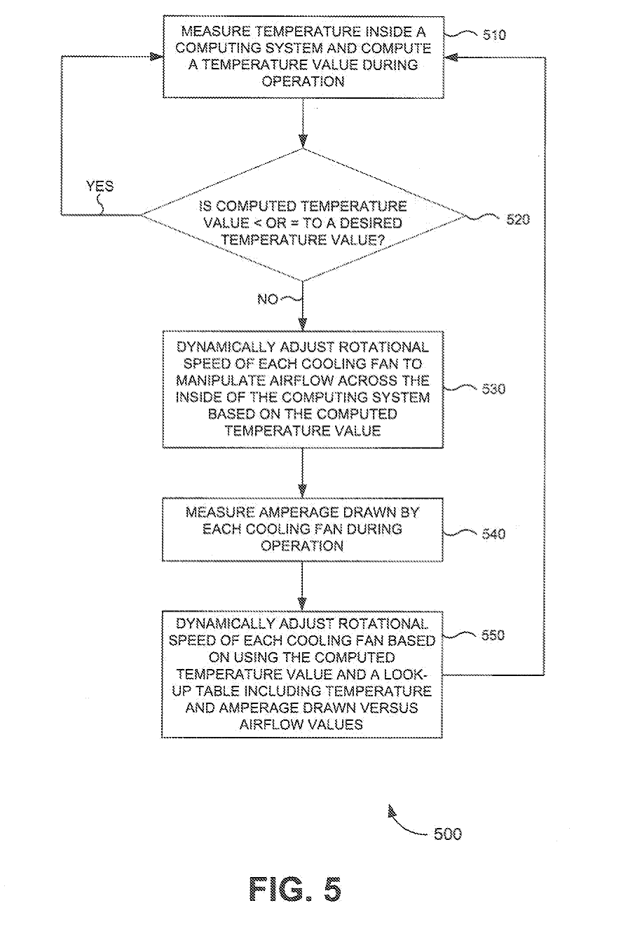

FIG. 5 is a flowchart 500 illustrating a cooling fan control method in a computing system 110, according to one embodiment. In some embodiments, in controlling a plurality of cooling fans 150 1-N in the computing system 110, the computing system 110 has a server chassis 120, a plurality of server blades 130 and the plurality of cooling fans 150 1-N attached to the server chassis 120.

In operation 510, temperature inside a computing system 110 is measured and a temperature value is computed during operation (e.g., using the temperature sensing module 210 of FIG. 2). In some embodiments, a plurality of temperature sensors 140 disposed within the computing system 110 measures the temperature of components requiring thermal control. In operation 520, it is determined whether the computed temperature value is less than or equal to a desired temperature value.

The process 500 performs operation 530 if the computed temperature value is not less than or equal to the desired temperature value, else the process 500 repeats operation 510. In operation 530, rotational speed of each cooling fan 150 is dynamically adjusted to manipulate airflow across the inside of the computing system 110 based on the computed temperature value.

In operation 540, amperage drawn by each cooling fan 150 is measured during operation. In some embodiments, a plurality of amperage sensors 160 associated with the plurality of cooling fans 150 1-N measure the amperage drawn by each cooling fan 150. In operation 550, rotational speed of each cooling fan 150 is dynamically adjusted to manipulate the airflow across the inside of the computing system 110 based on using the computed temperature value, a desired temperature value, and a lookup table including temperature and amperage drawn versus airflow values for each cooling fan 150.

In some embodiments, dynamically adjusting the rotational speed of each cooling fan 150 to manipulate the airflow includes dynamically adjusting the rotational speed of each cooling fan 150 to manipulate the airflow drawn across the server blades 130 and via the plurality of cooling fans 150 1-N based on using the computed temperature value, the desired temperature value, the lookup table including temperature and amperage drawn versus airflow values for each cooling fan 150.

In these embodiments, the lookup table including the temperature and amperage drawn versus the air flow values associated with each cooling fan 150 is stored in memory 240. In some embodiments, the airflow is based on cubic feet per minute (CFM) and the fan current drawn is based on amps. Upon performing the operation 550, the process 500 is routed back to operation 510 and repeat operations 510-550 until optimum airflow is obtained in the computing system 110.

The above-described cooling fan control method in the computing system 110 results in an even and optimum airflow by using amperage drawn measurements of the cooling fans 150 1-N. Also, the above-described method enables dynamically adjusting (e.g., up or down) of the fan speeds until the fan speed is rebalanced optimally and desired airflow is achieved. Further, the above-described technique facilitates saving of power in the computing system 110 due to non-linear relationship between the fan current drawn by the cooling fans 150 1-N in amps and the airflow generated by the fans 150 1-N in CFM.

The cooling fan control device (CFCD) 170 described above provides a central management entity in the server blade enclosure instrumentation such that an efficient cooling fan amperage balancing algorithm may be employed by dynamically optimizing the airflow as cooling fan blades of different airflow impedance are added and removed from the blade server enclosure. Thus, by automating airflow efficiency, all the cooling fan blades are ensured a consistent airflow across their component parts with less need for thermal testing a matrix of possibilities.

It will be appreciated that the various embodiments discussed herein may not be the same embodiment, and may be grouped into various other embodiments not explicitly disclosed herein. In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A cooling fan control device (CFCD) for controlling a plurality of cooling fans located in a computing system, comprising:
a temperature sensing module for measuring an inside temperature of the computing system using a plurality of temperature sensors disposed within the computing system and for computing a temperature value during operation;
a power measurement module for measuring amperage drawn by each of the plurality of cooling fans during operation; and
a driving module coupled to the temperature sensing module and the power measurement module to adjust rotational speed of each of the plurality of cooling fans during operation to obtain a desired airflow across the inside of the computing system based on the computed temperature value, a desired temperature value, and a lookup table including temperature and amperage drawn versus airflow values associated with each cooling fan.

2. The CFCD of claim 1, wherein the airflow is based on cubic feet per minute (CFM) and the fan current drawn is based on amps.

3. The CFCD of claim 1, further comprising:
at least one of a random access memory (RAM) and a read only memory (ROM) device for storing the lookup table including temperature and amperage drawn versus airflow values associated with each cooling fan.

4. The CFCD of claim 3, wherein the driving module adjusts the rotational speed of the plurality of cooling fans to obtain the desired airflow across server blades and via the plurality of cooling fans based on the computed temperature value and the lookup table including temperature and amperage drawn versus airflow values in CFM stored in the at least one of the RAM device and the ROM device.

5. The CFCD of claim 3, wherein the driving module adjusts the rotational speed of the plurality of cooling fans to obtain the desired airflow across server blades and via the plurality of cooling fans to meet the desired temperature value based on the computed temperature value and a cooling fan amperage balancing algorithm.

6. The CFCD of claim 5, wherein the desired temperature value is based on temperature of components requiring thermal control.

7. A computing system, comprising:
a server chassis;
a plurality of server blades disposed on the server chassis;
a plurality of cooling fans disposed on the server chassis such that the cooling fans can create an airflow across the plurality of server blades, wherein each cooling fan includes cooling fan blades;
a plurality of temperature sensors disposed on the server chassis and the plurality of server blades;
an amperage sensor associated with each cooling fan; and
a CFCD communicatively coupled to the plurality of temperature sensors for controlling the plurality of cooling fans and the amperage sensor associated with each cooling fan, wherein the CFCD is disposed on the server chassis, wherein CFCD measures inside temperature across the plurality of server blades during operation using the plurality of temperature sensors and computes a temperature value, wherein the CFCD measures amperage drawn by each of the plurality of cooling fans during operation using associated amperage sensors, and wherein the CFCD adjusts rotational speed of each of the plurality of cooling fans based on the computed temperature value and a desired temperature value to obtain a desired airflow across the plurality of server blades and via the cooling fan blades using a lookup table including temperature and amperage drawn versus airflow values for each cooling fan.

8. The computing system of claim 7, wherein the airflow is based on cubic feet per minute (CFM) and the fan current drawn is based on amps.

9. The computing system of claim 7, wherein the CFCD comprises:
at least one of a random access memory (RAM) device and a read only memory (ROM) device for storing the lookup table including temperature and amperage drawn versus airflow values associated with each cooling fan.

10. The computing system of claim 7, wherein the CFCD adjusts the rotational speed of the plurality of cooling fans to obtain a desired airflow across server blades and via the plurality of cooling fans to meet the desired temperature based on a computed temperature value and a cooling fan amperage balancing algorithm.

11. The computing system of claim 10, wherein the desired temperature value is based on temperature of components requiring thermal control.

12. The computing system of claim 7, wherein the CFCD comprises:
a temperature sensing module for measuring an inside temperature of the computing system using a plurality of temperature sensors disposed within the computing system and for computing a temperature value during operation;
a power measurement module for measuring amperage drawn by each of the plurality of cooling fans during operation; and
a driving module coupled to the temperature sensing module and the power measurement module to adjust rotational speed of each of the plurality of cooling fans during operation to obtain a desired airflow across the inside of the computing system based on the computed temperature value, a desired temperature value, and a lookup table including temperature and amperage drawn versus airflow values associated with each cooling fan.

13. A method of controlling a plurality of cooling fans in a computing system, comprising:
measuring temperature inside the computing system and computing a temperature value during operation;
dynamically adjusting rotational speed of each cooling fan to manipulate airflow across the inside of the computing system based on the computed temperature value.
measuring amperage drawn by each cooling fan during operation; and
dynamically adjusting rotational speed of each cooling fan to manipulate the airflow across the inside of the computing system based on using the computed temperature value, a desired temperature value, and a lookup table including temperature and amperage drawn versus airflow values for each cooling fan.

14. The method of claim 13, wherein measuring the temperature inside the computing system comprises:
measuring temperature of components requiring thermal control using a plurality of temperature sensors disposed within the computing system.

15. The method of claim 14, wherein measuring the amperage drawn by each cooling fan during operation comprises:
measuring the amperage drawn by each cooling fan during operation using a plurality of amperage sensors associated with the plurality of cooling fans.

16. The method of claim 13, wherein, in controlling the plurality of cooling fans in the computing system, the computing system has a server chassis, a plurality of server blades attached to the server chassis, and the plurality of cooling fans attached to the server chassis.

17. The method of claim 13, wherein dynamically adjusting the rotational speed of each cooling fan to manipulate the airflow comprises:
dynamically adjusting the rotational speed of each cooling fan to manipulate the airflow drawn across the server blades and via the plurality of cooling fans based on using the computed temperature value, the desired temperature value, the lookup table including temperature and amperage drawn versus airflow values for each cooling fan.

18. The method of claim 13, further comprising:
storing the lookup table including the temperature and amperage drawn versus the air flow values associated with each cooling fan in memory.

19. The method of claim 13, wherein the airflow is based on cubic feet per minute (CFM) and the fan current drawn is based on amps.
